(19) United States
(12) Patent Application Publication
(10) Pub. No.: US 2014/0083997 A1
(43) Pub. Date: Mar. 27, 2014

(54) COVER ASSEMBLY FOR A PORTABLE ELECTRONIC DEVICE

(71) Applicant: HEWLETT-PACKARD DEVELOPMENT COMPANY, L.P., Houston, TX (US)

(72) Inventors: Eric CHEN, Houston, TX (US); Ki Bok SONG, Katy, TX (US); Hui Leng LIM, Sugar Land, TX (US)

(73) Assignee: Hewlett-Packard Development Company, L.P., Houston, TX (US)

(21) Appl. No.: 13/627,139

(22) Filed: Sep. 26, 2012

(51) Int. Cl. B65D 8/04; H02J 7/00

(52) U.S. Cl. 220/4.02; 320/103

(57) ABSTRACT

Embodiments of the present invention disclose a cover assembly for a portable electronic device. According to one embodiment, a first cover element includes a first attachment feature and is formed to cover a first part of a rear surface of a portable electronic device, while a second cover element is formed to cover a second part of the rear surface of the portable electronic device and includes a second attachment feature configured to mate with the first attachment feature. Furthermore, the first attachment feature of the first cover element and the second attachment feature of the second cover element are configured to engage along a common edge so as to form a secure attachment in which the first cover element and second cover element cover the entire rear surface of the portable electronic device.

### BACKGROUND

The emergence and popularity of mobile computing has made portable electronic devices—due to theft compact design and light weight—a staple in today's marketplace. Though the portability of these mobile computing devices makes them highly conducive for easy transport, their thin frame and fragileness makes them easily susceptible to damage and failure caused by rough transportation conditions, liquid spills, or accidental drops. Consequently, many users elect to guard their valuable mobile device from damage using an external sleeve, cover, or carrying case. However, most of these protective accessories either have complicated assembly instructions or are not conducive to easy insertion and removal of the portable electronic device into/from said sleeve or cover.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1 is a three-dimensional perspective view of the cover assembly in a disengaged state according to an example of the present invention.

FIG. 2 is a three-dimensional front side view of the cover assembly and portable electronic device according to an example of the present invention.

FIG. 3 is a three-dimensional rear side view of the cover assembly with battery module and portable electronic device according to an example of the present invention.

FIG. 4 is a three-dimensional view of the cover assembly and portable electronic device in an engaged and assembled state according to an example of the present invention.

FIGS. 5A-5D are side views that illustrate one process for affixing the cover assembly onto a portable electronic device in accordance with an example of the present invention.

### DETAILED DESCRIPTION OF THE INVENTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to intimate that the scope of the disclosure, including the claims, is limited to that embodiment. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

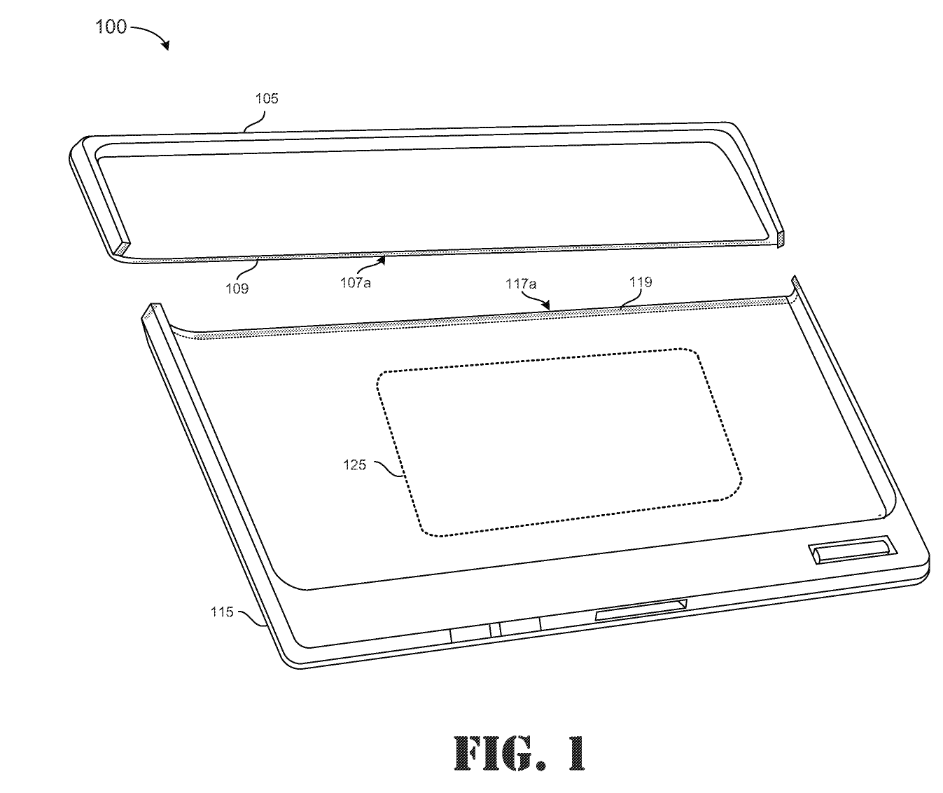

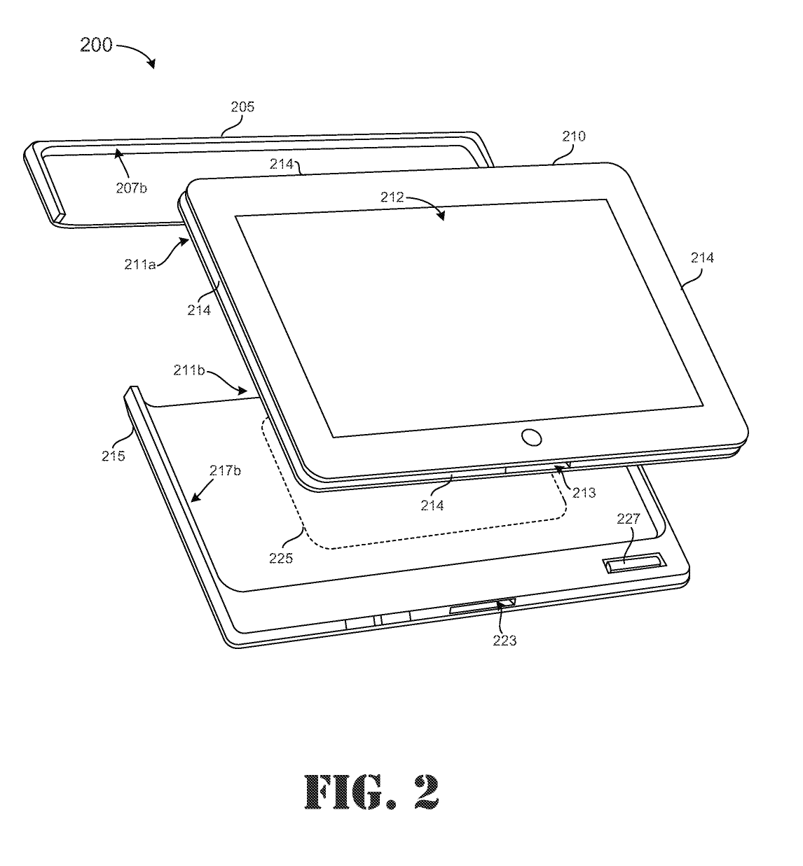

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

There have been several attempts to provide a simple and reliable protective sleeve for a portable electronic device such as a tablet computer. Examples of prior solutions include mechanical fasteners, elastic molds, hook-and-loop straps, and similar mechanisms that are used to hold the protective sleeve onto to tablet device. However, these solutions suffer from various problems in: 1) being overly difficult for the user to remove and/or place the sleeve on the device; 2) including loose parts that are easily misplaced, and/or 3) failing to provide a means for accessing ports of the device while the sleeve or cover is attached.

Embodiments of the present invention disclose a cover assembly for a portable electronic device. According to one example, the cover assembly includes a first sleeve portion and second sleeve portion, each having a magnetic feature formed along an edge thereof. When joined together via the magnetic features, the two sleeve portions are formed to cover an entire rear surface area of the tablet device. Moreover, one sleeve portion includes an extended battery module configured to wirelessly charge the tablet device when attached to the cover assembly. Thus, examples of the present invention provide a cover assembly having a reliable attachment means that also offers solid protection and additional functionality for an attached portable electronic device.

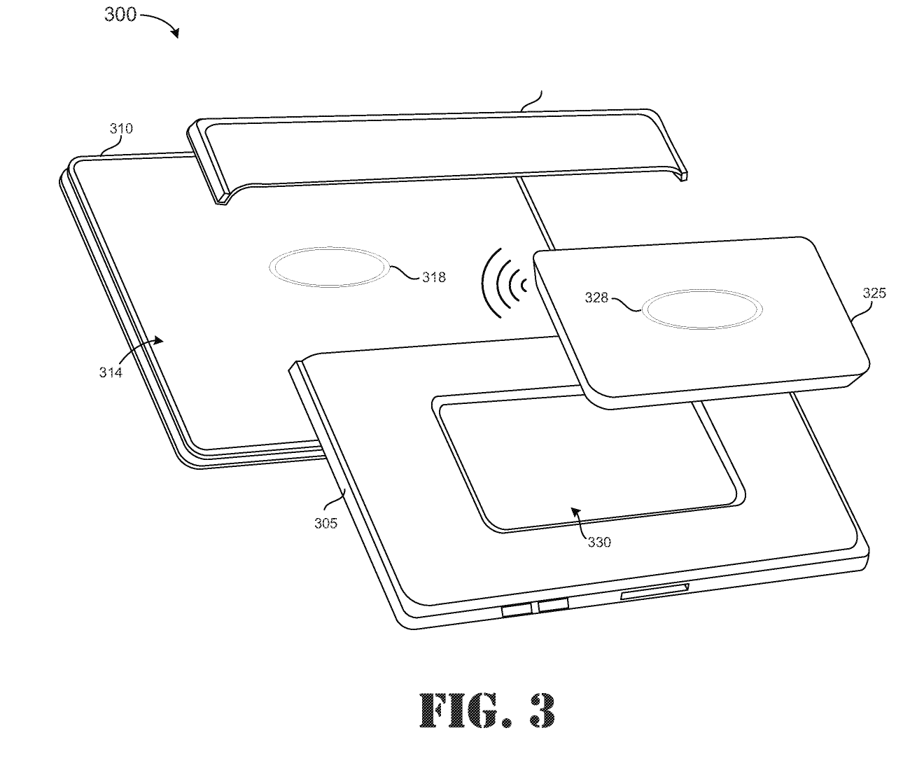

Referring now in more detail to the drawings in which like numerals identify corresponding parts throughout the views, FIG. 1 is a three-dimensional perspective view of the cover assembly in a disengaged state according to an example of the present invention. As shown here, the device jacket or cover assembly 100 includes a first sleeve portion 105 and a second sleeve portion 115. The first sleeve portion 105 is configured to cover an upper rear surface of a portable electronic device, while the second sleeve portion 115 covers a lower rear surface of the device. Furthermore, the connecting edge 107a of the first sleeve portion 105 includes a magnetic attachment feature 109 configured to engage and mate with a corresponding connecting edge 117a and magnetic attachment feature 119 of the second sleeve portion 115. More particularly, the magnetic features 109 and 119 are configured to provide a secure attachment means when the connecting or common edges 107a and 117a of the first portion 105 and second portion 107 are immediately adjacent or in contact with one another. That is, the first portion 105 and second portion 107 are configured to couple together around the device without an additional fastening element or external intervention. In addition, and according to one example embodiment, the second sleeve portion 115 includes a battery module 125 formed within a central cavity area of the second sleeve portion 115 as will be shown in further detail with reference to FIG. 3.

FIG. 2 is a three-dimensional front side view of the cover assembly and portable electronic device according to an example of the present invention. As shown in following example, the cover assembly or jacket 200 is formed to cover a surface area of a portable electronic device 210. The first sleeve portion 205 is configured to receive an upper area 211a of the tablet device 210, while the second sleeve portion 215 is configured to receive a lower area 211b of the tablet device 210. Both the inner edges 207b of the first sleeve portion 205 and inner edges 217b of the second sleeve portion are formed to correspond and engage with outer edges 214 of the portable electronic device 210 so as to enclose the enter perimeter of the tablet device 210 when in an assembled state. According to one example embodiment, the inner rail edges 207b and 217b of the sleeve portions 205 and 215 engage and form a friction fit with the outer rail edges 214 of the tablet device. Upon being joined, the sleeve portions 205 and 215 may be further secured using a screw or similar fixing means.

Furthermore, the cover assembly 200 is formed on the rear surface of the portable electronic device 210 so as to allow access to the display surface 212 (opposite rear surface) while the device 210 is enclosed by the cover assembly 200. In accordance with one example, the second sleeve portion 215 further includes a port aperture 223 for allowing access to the docking connector 213 of the portable electronic device 210 while the cover assembly 200 is affixed thereon. In addition, one or more port aperture(s) may be formed along an outer edge of the either the first sleeve portion 205 or the second sleeve portion 215 so as to enable user access to correspondingly located ports on the portable electronic device 210. Still further, the second sleeve portion 215 may also include a device unlock mechanism 227 such as finger print reader for providing a security unlock means for an enclosed tablet device 210.

FIG. 3 is a three-dimensional rear side view of the cover assembly with the battery module and portable electronic device according to an example of the present invention. In this example, the device jacket assembly 300 includes a first cover element 305, a second cover element 315, and a battery module 325. The first cover element 305 and second cover dement 315 are configured to span an entire rear surface area 314 (i.e., surface opposite display surface) of the portable electronic device 310. As shown here, the second cover element 315 may include an inner cavity 330 for housing a removable battery module 325, which is configured to inductively charge the portable electronic device 310. For example, the battery module 325 may include an induction coil 328 configured to create an alternating electromagnetic field so as to enable a second induction coil 318 of the table computer 310 to receive power from the electromagnetic field and charge an internal battery of the device 310. However, this is simply one method of wireless charging, and any wireless energy transfer method may be used as will be appreciated by one skilled in the art. According to one example, the cover assembly 300 may be formed of a polycarbonate ABS or similar thermoplastic material so as to allow inductive charging between the battery module 325 and portable electronic device 310 through near or physical contact via cavity area 330.

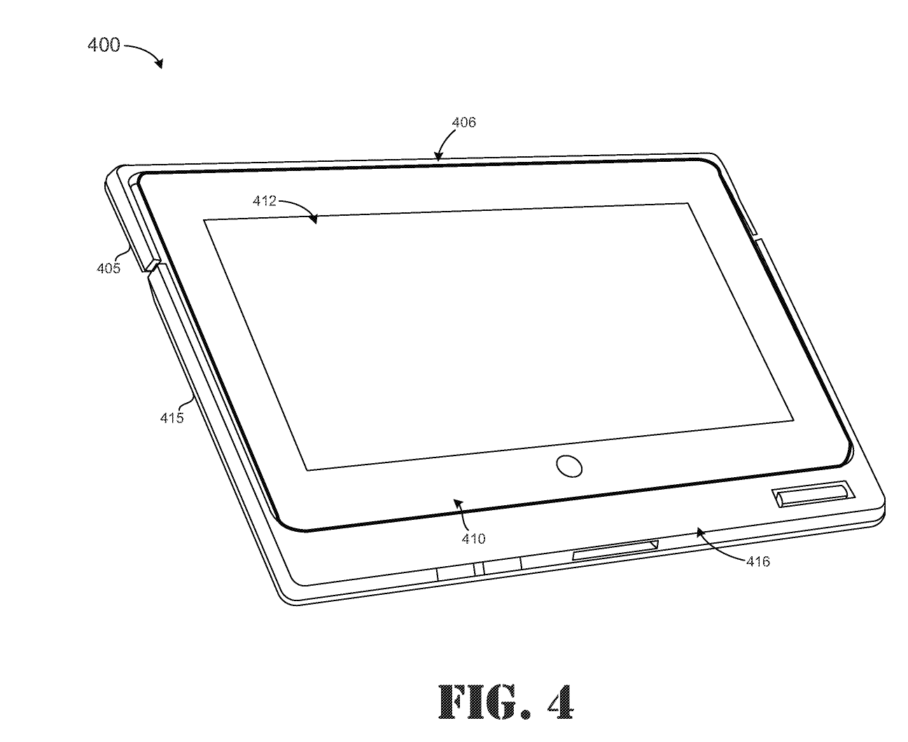

FIG. 4 is a three-dimensional view of the cover assembly and portable electronic device in an engaged and assembled state according to an example of the present invention. Specifically, magnetic features formed along connecting edges of the first sleeve portion 405 and the second sleeve portion 415 are configured to securely hold the first sleeve 405 and second sleeve 415 together in a fixed state such that outer edges of the tablet device 410 are firmly engaged with inner edges of the first sleeve portion 405 and second sleeve portion 410 (as shown in FIG. 2). In accordance with one example, the outer edges 406 and 416 of the cover assembly (i.e., sleeves 405 and 410 respectively) are configured to abut corresponding edges of the portable electronic device 410 while remaining flush with the display surface 412. As such, the cover assembly 400 and portable electronic device 410 are able to maintain a desirable slim and light profile package.

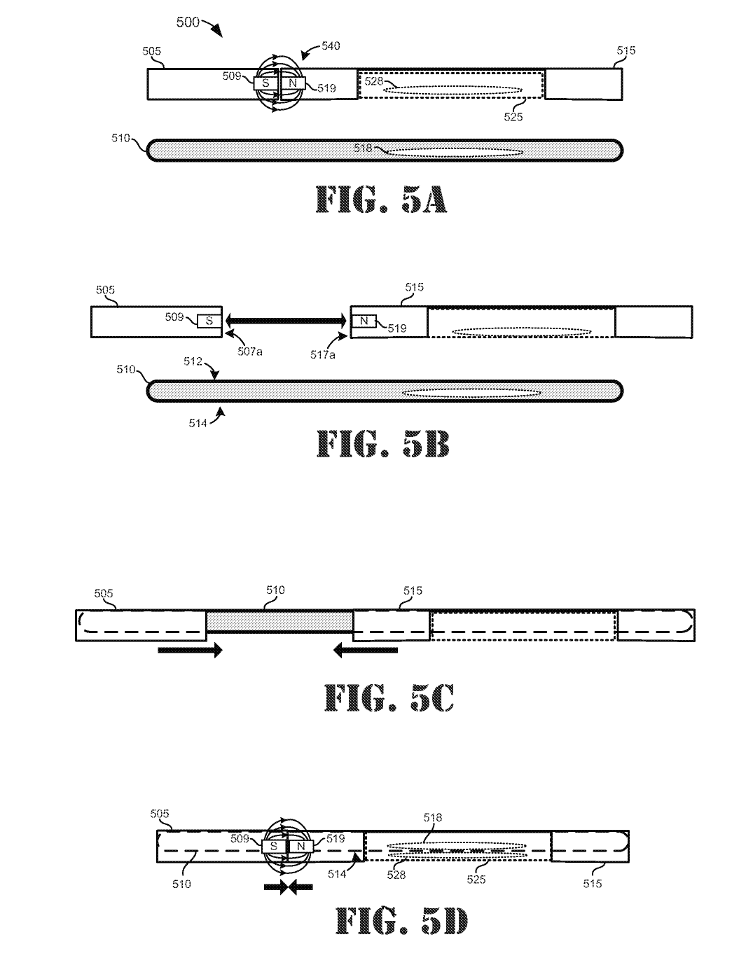

FIGS. 5A-5D are side views that illustrate one process for affixing the cover assembly onto a portable electronic device in accordance with an example of the present invention. FIG. 5A depicts the cover assembly 500 in a joined state and a separate portable electronic device 510. The first sleeve portion 505 and second sleeve portion 515 are coupled together at a common end via attachment features 509 and 519 respectively. In one example, the attachment features 509 and 519 represents magnetic elements having opposing poles that form a sufficiently strong magnetic field 540 that securely joins the first sleeve portion 505 and second sleeve portion 515. Additionally, the battery module 525 is formed within a cavity of the second sleeve portion 515 and may include an inductive coil 528 for enabling wireless power transfer with a second inductive coil 518 of the portable electronic device 510.

Referring now to FIG. 5B, the first sleeve portion 505 is physically separated and detached from the second sleeve portion 515. That is, external forces (as indicated by the directional arrow) pull the connecting edge 507a of the first sleeve portion 505 away from the connecting edge 517a of the second sleeve portion 515. Accordingly, the magnetic field formed by joining of attachment features 509 and 519 is disrupted. The first sleeve portion 505 is then placed or slid over an upper area of the tablet device 510 while the second sleeve portion 510 is placed (or slid along the edges) over a lower area of the tablet device 515 as shown in FIG. 5C. When in the fully assembled state, the magnetic features 509 and 519 of the first sleeve portion 505 and second sleeve portion 515 respectively, are joined along a common edge to form a secure casing around the rear surface of the portable electronic device 510 as shown in FIG. 5D. Still further, when in such a state the inductive coil 518 of the tablet device 510 is in close proximity to the inductive coil 528 of the battery module 525 associated with second sleeve portion 515 so as to enable wireless charging of tablet device 510 via the cover assembly 500. As shown, when in the assembled state, the first sleeve portion 505 and second sleeve portion 515 converge to cover and span an entire rear surface 514 of the tablet device 510. According to one example, the sleeve assembly only covers the rear and perimeter areas of the tablet device 510, and does not encroach on the display surface 512 of the tablet device 505 (i.e., edges of assembly are horizontally-aligned with edges of display surface 512).

Embodiments of the present invention provide a magnetic cover assembly for portable electronic device. Moreover, many advantages are afforded by the cover assembly in accordance with examples of the present invention. For instance, the magnetic features of the two-part design enable simple removal and installation of the cover assembly from/onto the portable electronic device. In addition, the battery module of the cover assembly serves to provide a back-up power supply that extends the battery life of an attached tablet device. Thus, examples of the present invention provide a reliable and functional cover assembly that can be easily manipulated b the user and help extend both the battery and cosmetic life of a portable electronic device.

Furthermore, while the invention has been described with respect to exemplary embodiments, one skilled in the art will recognize that numerous modifications are possible. For example, although exemplary embodiments depict a tablet computer as the portable electronic device, the invention is not limited thereto. For example, the portable electronic device may be an electronic reading device, a smart phone, or any other electronic device having a single housing and display surface formed on one side of said housing. Thus, although the invention has been described with respect to exemplary embodiments, it will be appreciated that the invention is intended to cover all modifications and equivalents within the scope of the following claims.

What is claimed is:

1. A device cover assembly comprising:
a first cover element having a first attachment feature and formed to cover a first part of a rear surface of a portable electronic device; and
a second cover element having a second attachment feature configured to mate with the first attachment feature and formed to cover a second part of the rear surface of the portable electronic device,
wherein the first attachment feature of the first cover element and the second attachment feature of the second cover element are configured to engage along a common edge so as to form a secure attachment whereby the first cover to element and second cover element cover the entire rear surface area of the portable electronic device.

2. The assembly of claim 1, wherein the first attachment feature is formed near an outer edge of the first cover element and the second attachment feature is feature is formed near an outer edge of the second cover element.

3. The assembly of claim 2, wherein the first attachment feature and the second attachment feature is magnetic.

4. The assembly of claim 3, wherein the second cover includes an outer cavity area for housing a removable battery module.

5. The assembly of claim 4, wherein the removable battery module is configured to provide power wirelessly to the portable electronic device when the first cover element and the second cover element are affixed onto the portable electronic device in an assembled state.

6. The assembly of claim 5, wherein the portable electronic device receives power from the removable battery via inductive charging.

7. The assembly of claim 3, wherein the first cover element and/or the second cover element include at least one connector aperture for allowing access to at least one correspondingly located port on portable electronic device while the first cover element and/or second cover element is attached to the rear surface of the portable electronic device.

8. The assembly of claim 7, wherein inner edges of the portable electronic device form a friction fit with outer edges of the portable electronic device.

9. The assembly of claim 1, wherein a front surface opposite the rear surface of the portable electronic device remains uncovered when the first cover element and second cover element are joined on the rear surface of the portable electronic device in an assembled state.

10. A cover assembly for a tablet computer comprising:
a first sleeve portion formed to cover an upper area of the rear surface of the tablet computer, wherein the first sleeve portion includes a first magnetic feature formed near an outer edge; and
a second sleeve portion formed to cover a lower area of the rear surface of the tablet computer, wherein the second sleeve portion includes a second magnetic feature formed near an outer edge and configured to mate with the first magnetic feature,
wherein the first sleeve portion and the second sleeve portion are configured to magnetically engage via the first magnetic feature and second magnetic feature so as to form a secure attachment such that the first sleeve portion and second sleeve portion span and cover the entire rear surface of the tablet computer.

11. The cover assembly of claim 10, wherein the second sleeve portion includes an outer cavity area for housing a removable battery.

12. The cover assembly of claim 11, wherein the removable battery is configured to wirelessly charge the tablet computer when the first sleeve portion and the second sleeve portion are affixed onto the tablet computer in an assembled state.

13. The cover assembly of claim 12, wherein the first sleeve portion and/or second sleeve portion include a connector aperture for allowing access to at least one correspondingly located port on the tablet computer while the first sleeve portion and second sleeve portion are in the assembled state.

14. The cover assembly of claim 13, wherein a display surface opposite the rear surface of the tablet computer remains uncovered when the first cover and second cover are affixed onto tablet computer in an assembled state.

15. A magnetic cover assembly for a tablet computer comprising:
a first sleeve member formed to cover an upper area of the rear surface of the tablet computer, wherein the first sleeve portion includes a first magnetic feature formed near an outer edge; and
a second sleeve member formed to cover a lower area of the rear surface of the tablet computer, wherein the second sleeve member includes an outer cavity area and a second magnetic feature formed near an outer edge and configured to mate with the first magnetic feature,
a removable battery formed to fit within the cavity housing and configured to wirelessly charge the tablet computer when the first sleeve member and the second sleeve member are affixed onto the tablet computer in an assembled state;
wherein the first sleeve member and the second sleeve member are configured to magnetically engage via the first magnetic feature and second magnetic feature in the assembled state so as to form a secure attachment whereby the first sleeve portion and second sleeve member cover the entire rear surface of the tablet computer,
wherein the first sleeve member and/or second sleeve member include a connector aperture for allowing access to at least one correspondingly located port on the tablet computer while the first sleeve member and second sleeve member are in an assembled state.
